(19) United States
(12) Patent Application Publication
(10) Pub. No.: US 2004/0178137 A1
(43) Pub. Date: Sep. 16, 2004

(54) Reinforcement structures for multi-cell filter cartridge

(76) Inventors: Koichi Itoh, Yokohama (JP); Hironobu Watanabe, Iwaki City (JP)

Correspondence Address: R. Thomas Payne, CUNO Incorporated, 400 Research Parkway, P.O. Box 1018, Meriden, CT, 06450-1018, US

(21) Appl. No.: 10/796,251

(22) Filed: Mar. 8, 2004

Related U.S. Application Data
(60) Provisional application No. 60/453,413, filed on Mar. 10, 2003.

(51) Int. Cl. B01D 35/00

(52) U.S. Cl. 210/346; 210/435; 210/486; 210/488

(57) ABSTRACT

Reinforcement structure for use with multi-cell filter cartridges comprising an elongated backbone having a first and second hook boss each at a respective end of the elongated backbone and one or more intermediate hook bosses positioned intermediate the end bosses along the elongated backbone. In addition a plurality of non hook bosses are spaced along the elongated backbone. The filter cartridge provided with a plurality of the described reinforcement structures equally spaced around the circumference of the filter cartridge is also disclosed as is a method for preventing distortion of a multi-cell filter cartridge under arduous operating conditions.

### CROSS REFERENCE TO RELATED APPLICATIONS

This application is a continuation-in-part of and claims the benefit from provisional application Ser. No. 60/453,413 filed Mar. 10, 2003 which is hereby incorporated by reference to the extent not inconsistent with the present disclosure.

### BACKGROUND OF THE DISCLOSURE

The present disclosure relates to reinforcement structure(s) for use with multi-cell filter cartridges and, more particularly, to reinforcement structures that cooperate with multi-cell filter cartridges to minimize or prevent distortion, as for example might occur during heat sterilization and/or sanitization, and to enhance cartridge stability and performance. The disclosed reinforcement structures provide a simple and cost effective way to reduce or prevent cell distortion in multi-cell filter cartridge systems without any need to modify any of the features of the filter cartridge construction.

Multi-cell filtration filters are well known in the filtration art and generally include a plurality of stacked cells or discs. These filtration cartridges may encounter disadvantageous distortion, e.g. when exposed to arduous operating conditions, heat sanitization and/or heat sterilization, and particularly repetitive hot water sanitation cycles.

In one such known filter cartridge, the filter cartridge includes a plurality of stacked filter cells, as are known in the art. Additionally, the filter cartridge includes a known feature that is intended to limit loss of space between cells by cell distortion, namely relatively stiff injection molded tabs beneath the edge of each cell which tabs are intended to act as relatively stiff separators. These tabs, regardless of their precise shape, are intended to maintain a minimum space between cells when the cartridge is subjected to arduous operating conditions giving rise to distortion.

In a pending Japanese patent application (P2001-113108A), a filter cartridge is disclosed wherein the cross section of the cell edge mold is asymmetrically designed so that distortion of cells always occurs to the same direction. Although combination of this asymmetric practice with edge tabs helps to maintain minimum space between cells, this approach is less than desirable because distortion is still allowed to occur, with the negative visual and performance associated therewith.

Another attempt to minimize distortion in filter cartridges is to fabricate them entirely from plastic parts. However, this approach to addressing potential filter cartridge distortion is generally disadvantageous because the weight of the filter cartridge may become unacceptably heavy (particularly after use), and the exclusive use of plastic parts in fabricating filter cartridges generally sacrifices flow rate performance.

Two recent PCT publications reflect further industry efforts in the field of multi-cell filter cartridges. Both PCT applications were filed on behalf of Seitzschenk Filtersystems GmbH. The first PCT publication, WO 01/17656, was published on Mar. 15, 2001 and is entitled “Filter Module Comprising Tensioning Elements” and discloses a filter module that includes a plurality of circular filter cells (1). The filter cells are separated by spacer rings (3). A pair of end rings (4) are also provided. The filter module forms a stack of filter cells which define a continuous channel (2). The PCT publication WO 01/17656 further discloses tensioning elements, as follows:

[T]ensioning elements (5) . . . are interspersed in the circumferential direction of the channel wall and . . . , on the inner side, engage on the end rings (4) in order to transmit axial tension forces. According to the invention, tensioning elements comprised of strips (5) with hook-shaped ends (6, 13, 14) are provided for securely combining the filter cells that are arranged in a stack. Said hook-shaped ends can be fixed in the end rings by effecting an essentially radial hooking-in or engaging movement. In addition, means (10, 11) are provided which prevent an unintentional radial hook-removal or disengaging movement of the hook-shaped ends (6, 13, 14).

The second PCT publication, WO 02/00320, was published on Jan. 3, 2002 and is entitled “Filter Module.” The object of the filter module disclosed in this PCT publication “is to combine the advantages of known filter modules with improved sealing at the edges of the filter layers, and to make the filter module backwashable.” The disclosed filter module (1) in WO 02/00320 includes a plurality of filter layers and interspersed draining spacer elements which may be “pressed in a sealing manner.” Flow elements (12a, b) and sealing elements (11a, b) are provided at the periphery of the module to facilitate backwashing of the module. “Connecting means include lugs, stirrup straps (16a, b, 23a, b), and T and arrow-shaped catch elements.” In addition, in the disclosed filter module, the media is sealed with a pinch fit at the edges by pressing together the plastic parts. The media thickness needs to be well controlled to ensure that the pinch seals, and the plastic parts will provide meaningful compensation for media that varies in thickness or density.

Despite efforts to date, a need remains for structures that provide superior cartridge integrity, i.e., enhanced stability and reduced distortion in multi-cell filter cartridges, when they are subjected to arduous operating conditions including heat sanitization and/or sterilization. These and other needs and objectives are achieved by the reinforcement structures and multi-cell filter cartridge assemblies disclosed herein. Additional advantageous features and functionalities associated with the disclosed reinforcement structures will be apparent from the appended figures and detailed description of exemplary embodiments which follow.

### SUMMARY OF THE DISCLOSURE

According to the present disclosure, advantageous reinforcement structures are disclosed for use with multi-cell filter cartridges. The disclosed reinforcement structures, have the advantage of a simple, low cost/long life filter cartridge construction providing enhanced stability and reducing or eliminating potential distortion of the filter cartridge, i.e., providing maximum cartridge integrity under arduous operating conditions including repetitive heat sanitization and/or sterilization of the filter cartridge.

In exemplary embodiments of the present disclosure, a plurality of reinforcement structures are detachably secured to the multi-cell filter cartridge at circumferentially spaced locations. In one example, four reinforcement structures may be secured to the multi-cell filter cartridge at locations spaced by about 90° around the circumference of the multi-cell filter cartridge. Alternatively, three reinforcement structures may be employed at locations spaced by about 120°. It may also be possible, for some applications, that there are two reinforcement structures secured to the multi-cell filter cartridge spaced apart by 180°. According to preferred embodiments of the present disclosure, as many as necessary reinforcement structures to achieve the desired effect in reduction of cell distortion are substantially equally spaced around the circumference of the filter cartridge. Although a plurality of alternative configurations and/or deployments may be employed, as will be apparent to persons skilled in the art, it is presently believed that as many as 8 to 12 reinforcement structures and possibly more may be advantageously employed to achieve the desired effect in reduction of cell distortion.

Exemplary reinforcement structures according to the present disclosure are generally fabricated from a substantially rigid material, e.g., a suitable plastic. Each of the disclosed reinforcement structures includes at least one attachment feature for detachably securing the reinforcement structure relative to the filter cartridge and, in exemplary embodiments of the disclosed reinforcement structures, a plurality of attachment features for detachably securing the reinforcement structure relative to a filter cartridge are provided. According to a preferred embodiment of the present disclosure, the reinforcement structure defines an elongated member that includes hook bosses at each end thereof. In addition, one or more intermediate hook bosses are provided in exemplary embodiments of the present disclosure to facilitate attachment of the reinforcement structure to the filter cartridge. Additional non-hook bosses are generally defined in a spaced manner along the elongated member for cooperative alignment with spaces or openings between the stacked cells. In exemplary embodiments of the present disclosure, the number of bosses formed on the elongated member between respective hook bosses is equal to the number of spaces between the stacked cells over the same distance.

In use, the disclosed reinforcement structures are secured in a circumferentially spaced manner to a multi-cell filter cartridge by securing the hook bosses to the cooperative filter cartridge structure and interposing the non-hook bosses into the spaces formed between corresponding adjacent filter cells. The non-hook bosses are generally dimensioned to be narrower than the space between adjacent cells, e.g., by about 0.5 to about 3.0 mm, thereby facilitating positioning of the non-hook bosses in the corresponding spaces. Despite the small clearance between the non-hook bosses and the opposing cells, the disclosed reinforcement structures are effective in reducing/preventing distortion from occurring between the cells.

Of note, the disclosed reinforcement structures reduce/prevent distortion by providing both tensile and compressive anti-distortive forces. More particularly, by securing the reinforcement structure at or near the top and bottom of the filter cartridge, any distortive force that would seek to spread the top from the bottom on that side of the filter cartridge would be opposed by a tensile force. In addition, any distortive force that would seek to move the top closer to the bottom on that side of the filter cartridge would be opposed by a compressive force, e.g., based in part on the presence of the interposed non-hook bosses. The improved “tensioning”/“compressing” contributes significantly to the cartridge integrity.

Thus, the disclosed reinforcement structures advantageously address the distortion problem encountered in multi-cell filter cartridges, particularly after heat sterilization or sanitization, at a customer location. Resolving the potential distortion problem is important because the direction of distortion is rather random, and such distortion results in loss of space between opposing cells in different portions or regions of the filter cartridge. At a minimum, distortion may raise concerns for the customer/user of the filter cartridge, e.g., resulting in a negative customer impression about the integrity of the filter cartridge during use. If sufficient distortion is experienced, effective filtration area of the cartridge may be lost, which produces negative results, including poor flow, poor media utilization and shorter filtration life. The disclosed reinforcement structure advantageously obviates such potential problems by preventing (or significantly reducing) distortion of the multi-cell filter cartridge. Moreover, the disclosed reinforcement structure advantageously permits continued injection molding of the edge seal around the media, thereby ensuring reliable sealing of the media at the outer periphery, regardless of variations in media thickness and density.

Additional features and functions of the disclosed reinforcement structure will be apparent from the appended figures and the detailed description which follows.

### BRIEF DESCRIPTION OF THE FIGURES

To assist those of ordinary skill in the relevant art to which the subject matter of the present disclosure relates to better understand the features, operations and uses hereof, reference is made to the attached figures and corresponding description, in which:

FIG. 1 illustrates a multi-cell filter cartridge with which the reinforcement structure of the present disclosure may be advantageously employed;

FIG. 2 illustrates a multi-cell filter cartridge with an exemplary embodiment of the disclosed reinforcement structure secured thereto; and

FIG. 3 illustrates an exemplary reinforcement structure according to the present disclosure.

### DETAILED DESCRIPTION OF EXEMPLARY EMBODIMENT(S)

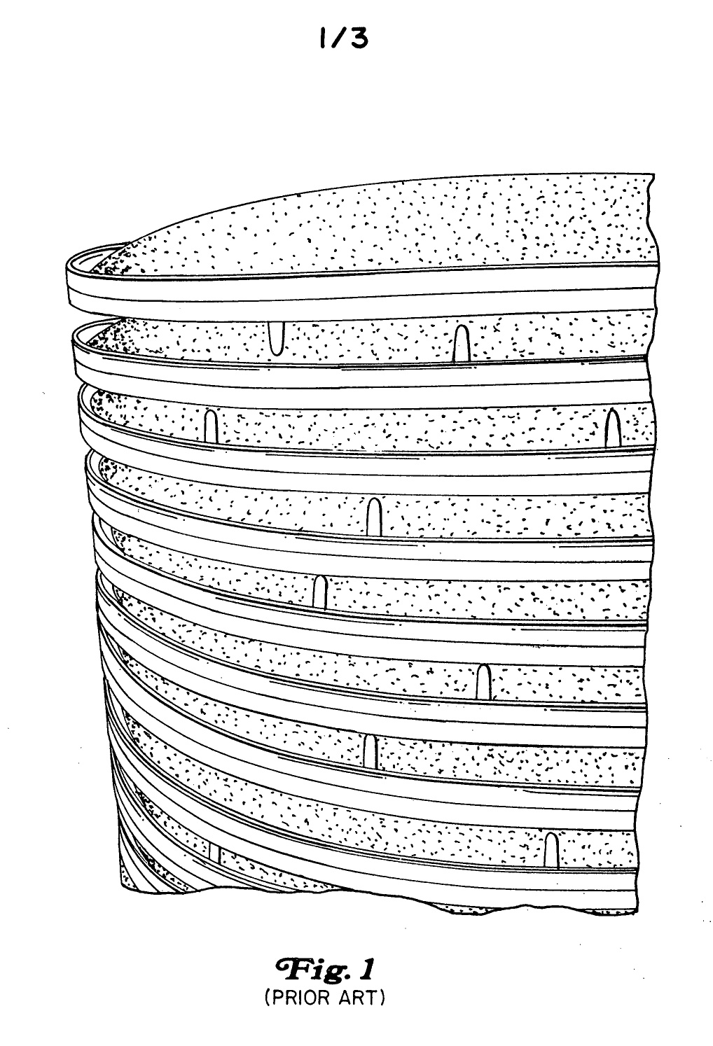

FIG. 1 shows a known multi-cell filter cartridge which includes a plurality of stacked filter cells and additionally includes relatively stiff injection molded tabs beneath the edge of each cell for limiting loss of space between cells by cell distortion.

Advantageous reinforcement strictures are disclosed herein for use with multi-cell filter cartridges, as for example, the Zeta Plus® filter cartridge commercially available from Cuno, Inc. (Meriden, Conn.). The herein disclosed reinforcement structures provide a cost effective and easy way to achieve enhanced stability of the filter cartridge, and to reduce or eliminate potential distortion of the filter cartridge, e.g., potential distortion associated with heat sanitization and/or sterilization of the filter cartridge.

The disclosed reinforcement structures find utility in a wide range of filter cartridge systems, particularly multi-cell filter cartridges. As used herein, a “cell” is generally directed to a double sided disc made of filter media which is joined at the outer edge with an edge seal. To form a multi-cell filter cartridge, a cell is stacked with other cells to make up the cartridge assembly.

As noted above, the disclosed reinforcement structures advantageously minimize and/or eliminate distortion that may otherwise be experienced by the multi-cell filter cartridge. Deformation evidences itself in a multi-cell filter cartridge when the stacked discs are no longer in a straight line (or substantially straight line). Deformation may either change the space between the cells or evenly warp all of the cells, such that the filter cartridge assumes a visually unacceptable appearance. The filter cartridge may also experience unacceptable performance degradation, flow realization, media utilization and hence shortened life spans. Deformation typically occurs due to arduous operating conditions including thermal cycling of the filter cartridge, although other distortive causes may be encountered.

Two particular causes of distortion are hot water sanitization and in-situ steam sterilization. Hot water sanitization generally involves a cleaning procedure in which water circulates through the cartridge assembly at elevated temperatures, typically temperatures of 60° C. or above. In-situ steam sterilization generally involves a cleaning procedure in which steam circulates through the cartridge assembly at elevated temperatures, typically at temperatures of 121° C. or above. In both cases, random distortion of a conventional multi-cell filter cartridge may result.

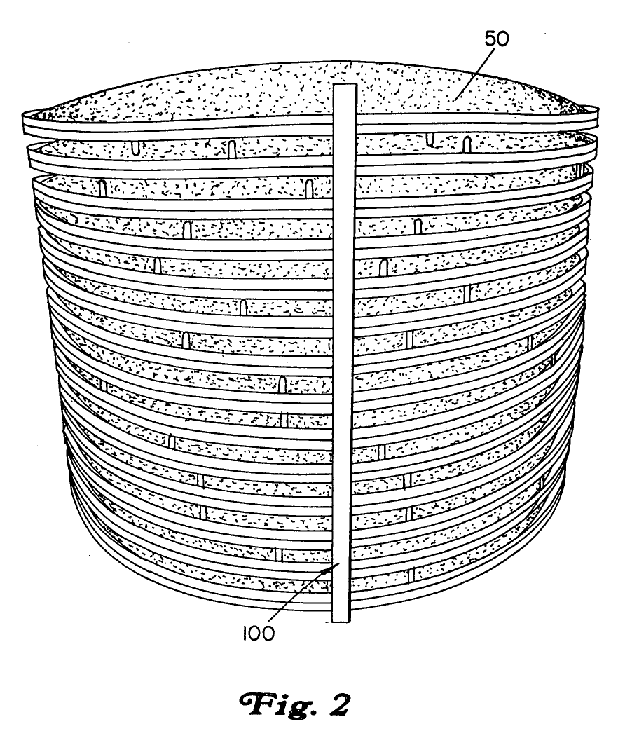

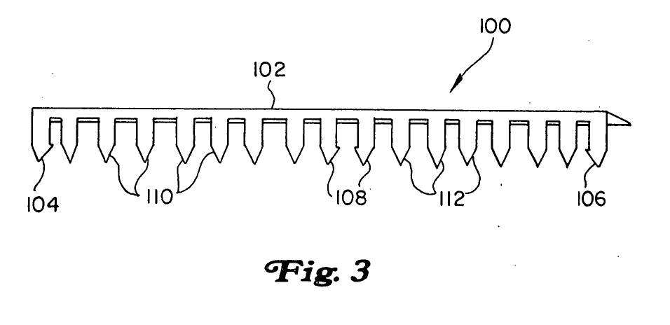

With reference to FIGS. 2 and 3, an exemplary embodiment of the reinforcement structure of the present disclosure is depicted. In FIG. 2, an exemplary reinforcement structure 100 is deployed on a conventional multi-cell filter cartridge 50. Although only a single reinforcement structure 100 is visible in FIG. 2, it is contemplated that a plurality of circumferentially spaced reinforcement structures would be detachably secured to filter cartridge 50, e.g., four reinforcement structures may be secured at locations circumferentially spaced by about 90°, or three reinforcement structures at locations circumferentially spaced by about 120°. According to preferred embodiments, the reinforcement structures are substantially equally spaced around the circumference of filter cartridge 50, although alternative deployment patterns may be employed based on particular circumstances, as will be apparent to persons skilled in the art.

Specifically, it may also be possible, for some applications, that there are two reinforcement structures secured to the multi-cell filter cartridge spaced apart by 180°. According to preferred embodiments of the present disclosure, as many reinforcement structures as necessary to achieve the desired effect in reduction of cell distortion are substantially equally spaced around the circumference of the filter cartridge. Although a plurality of alternative configurations and/or deployments may be employed, as will be apparent to persons skilled in the art, it is presently believed that as many as 8 to 12 reinforcement structures and possibly more may be advantageously employed to achieve the desired effect in reduction of cell distortion.

Thus, it is specifically contemplated that the number and relative positioning of reinforcement structures deployed or attached to a filter cartridge may be varied without departing from the spirit or scope of the present disclosure.

With particular reference to FIG. 3, exemplary reinforcement structure 100 is depicted. Reinforcement structure 100 includes an elongated backbone 102 that features a relatively flat face on one side, and a series of bosses (discussed in greater detail below) extending from the other side. Reinforcement structure 100 is generally fabricated from a substantially rigid material, such as a suitable plastic. Reinforcement structure 100 may be advantageously fabricated using conventional injection molding techniques, although alternative fabrication techniques may be employed, as will be apparent to persons skilled in the art. The material of construction for reinforcement structure 100 may be varied depending on the material of cartridge construction part, such as of high density polypropylene, polyethylene (HDPE), nylon, polyvinylidene fluoride (PVDF), and the like.

With further reference to FIG. 3, reinforcement structure 100 includes a first hook boss 104 at a first end of backbone 102 and second hook boss 106 at a second end of backbone 102. Although the reinforcement structure depicted in FIG. 3 includes a plurality of hook bosses, it is contemplated that the reinforcement structure includes at least one attachment feature, e.g., hook boss, to detachably secure the reinforcement structure relative to the filter cartridge. Hook bosses 104, 106 are dimensioned and configured to detachably hook to a filter cartridge, e.g., filter cartridge 50 as depicted in FIG. 2. In addition, intermediate hook bosses 108 extend from backbone 102, e.g., at or near the midpoint of backbone 102 (although, as noted above, it is contemplated that a single hook boss may be effective in detachably securing the reinforcement structure to a filter cartridge, i.e., a hook boss at an end or intermediate position thereon). Intermediate hook bosses 108 are also dimensioned and configured to detachably hook to a filter cartridge. The precise attachment features associated with hook bosses 104, 106, 108 is not critical to the design or operation of the reinforcement structure of the present disclosure, provided the hook bosses are effective in maintaining attachment to the filter cartridge during normal use of the filter cartridge.

Between first hook boss 104 and intermediate hook bosses 108 are a first plurality of non-hook bosses 110. Similarly, between second hook boss 106 and intermediate hook bosses 108 are a plurality of non-hook bosses 112. The non-hook bosses 110, 112 are generally defined in a spaced manner along elongated backbone 102 for cooperative alignment with spaces or openings between the stacked cells of the filter cartridge, e.g., filter cartridge 50 of FIG. 2. In exemplary embodiments of the present disclosure, the number of non-hook bosses 110, 112 formed on the elongated backbone 102 between respective hook bosses is equal to the number of spaces between the stacked cells of the filter cartridge over the same distance. However, the precise number and spacing of non-hook bosses may be varied along backbone 102 without departing from the spirit and scope of the present disclosure, as will be apparent to persons skilled in the art.

The non-hook bosses 110, 112 are generally dimensioned to be narrower than the space defined between cells of the filter cartridge, e.g., by about 0.5 to 1.0 mm, thereby facilitating positioning of the non-hook bosses in the corresponding spaces. Despite the small clearance between the non-hook bosses 110, 112 and the opposing cells, the disclosed reinforcement structure 100 is effective in reducing/preventing distortion between the cells.

In use, the disclosed reinforcement structures 100 are secured in a circumferentially spaced manner to a multi-cell filter cartridge 50 by securing the hook bosses 104, 106, 108 to the cooperative filter cartridge structure and interposing the non-hook bosses 110, 112 into the spaces formed between corresponding adjacent filter cells. The disclosed reinforcement structures 100 advantageously address the distortion problem encountered in multi-cell filter cartridges, particularly after heat sterilization or sanitization, e.g., at a customer location. Of note, the design and use of the disclosed reinforcement structures advantageously permit the edge seal to be injected molded around the media, thereby ensuring reliable sealing of the media at the outer periphery, regardless of variations in media thickness and density.

The disclosed reinforcement structures 100 reduce/prevent distortion by providing both tensile and compressive anti-distortive forces. By securing a reinforcement structure 100 at or near the top and bottom of the filter cartridge, any distortive force that would seek to spread the top from the bottom on that side of the filter cartridge would be opposed by a tensile force imparted by reinforcement structure 100. In addition, any distortive force that would seek to move the top closer to the bottom on that side of the filter cartridge would be opposed by a compressive force imparted by reinforcement structure, e.g., based in part on the presence of the interposed non-hook bosses 110, 112 within the corresponding spaces defined by the filter cartridge.

The reinforcement structures of the present disclosure are important, at least in part because resolving the potential distortion problem addresses the potential loss of space between opposing cells in different portions or regions of the filter cartridge. At a minimum, distortion may raise concerns for the customer/user of the filter cartridge, e.g., resulting in a negative customer impression about the integrity of the filter cartridge during use. Indeed, if sufficient distortion is experienced, effective filtration area of the cartridge may be lost, which has negative implications for filter performance, e.g., shorter filtration life. As used herein, the effective filtration area of a multi-cell filter cartridge refers to the section of the filter media in the cartridge which is available to filter the fluid. The filter media involved in filtering fluid is less than the total amount of filter material used to construct the filter because, inter alia, some of the media is used to seal the cartridge. The disclosed reinforcement structure advantageously obviates the above-noted problems and potential problems of reduced flow and media utilization resulting in decreased life by preventing (or significantly reducing) distortion of the multi-cell filter cartridge.

Although the reinforcement structures of the present disclosure have been described with reference to specific exemplary embodiments, the scope of the present disclosure is not be restricted to the specifics of those exemplary embodiments. Thus, numerous alternative embodiments are contemplated that embody unique and advantageous aspects of the present disclosure. For example, it is contemplated that the disclosed reinforcement structures may be used with filter cartridges of different designs, including without limitation, filter cartridges that include a proprietary netted cell construction and that such reinforcement structure deployment may enhance benefit of netting for back pressure resistance. Such alternative embodiments are to be included within the spirit and scope of the present disclosure.

1. A reinforcement structure for use with a filter cartridge, comprising an elongated backbone have a bottom surface and a top surface, at least one hook boss, and a plurality of non-hook bosses extending from the bottom surface.

2. A reinforcement structure according to claim 1, wherein a plurality of hook bosses extends from the bottom surface of said elongated backbone and wherein said plurality of hook bosses includes first and second hook bosses each being located at or near a respective end of the elongated backbone.

3. A reinforcement structure according to claim 1, wherein a plurality of hook bosses extends from the bottom surface of said elongated backbone and wherein said plurality of hook bosses includes one or more intermediate hook bosses.

4. A reinforcement structure according to claim 3, wherein said one or more intermediate hook bosses are positioned inwardly of the respective ends of the elongated backbone.

5. A reinforcement structure according to claim 4 wherein said one or more intermediate hook bosses are positioned at or near the midpoint of the elongated backbone.

6. A reinforcement structure according to claim 1, wherein said plurality of non-hook bosses are spaced along the elongated backbone.

7. A reinforcement structure according to claim 1, wherein said plurality of non-hook bosses are dimensioned to be slightly narrower than the space defined between cells of a filter cartridge to which the reinforcement structure is to be attached.

8. A reinforcement structure according to claim 1, wherein the elongated backbone and hook/non-hook bosses are fabricated from a plastic material.

9. A reinforcement structure according to claim 8, wherein said fabrication is by injection molding techniques.

10. A reinforcement structure according to claim 8 wherein said plastic material is a member selected from the group consisting of polypropylene, polyethylene, nylon and polyvinylidene fluoride.

11. A filter cartridge assembly, comprising a filter cartridge and a plurality of reinforcement structures as defined by claim 1 detachably secured thereto.

12. A filter cartridge assembly comprising a filter cartridge and a plurality of reinforcement structures as defined by claim 2.

13. A filter cartridge assembly comprising a filter cartridge and a plurality of reinforcement structures as defined by claim 3.

14. A filter cartridge assembly comprising a filter cartridge and a plurality of reinforcement structures as defined by claim 5.

15. A filter cartridge assembly comprising a filter cartridge and a plurality of reinforcement structures as defined by claim 6.

16. A filter cartridge assembly comprising a filter cartridge and a plurality of reinforcement structures as defined by claim 7.

17. A filter cartridge assembly according to claim 11, wherein said plurality of reinforcement structures are detachably secured to the filter cartridge in a circumferentially spaced manner.

18. A filter cartridge assembly according to claim 11, wherein the circumferential spacing is from about 30° to about 120°.

19. A filter cartridge assembly according to claim 11, wherein the reinforcement structures impart tensile and compressive forces in opposition to potential distortive forces encountered by the filter cartridge.

20. A filter cartridge assembly according to claim 11, wherein the filter cartridge is a multi-cell filter cartridge.

21. A method for preventing distortion of a multi-cell filter cartridge under arduous operating conditions which comprises providing a filter cartridge comprised of a plurality of cells vertically stacked one upon the other with a reinforcing structure according to claim 1 detachably secured vertically along the outer circumference of said cartridge so as to minimize or prevent distortion of the cells when the filter cartridge is subjected to arduous operating conditions.
